(19) United States
(12) Patent Application Publication
(10) Pub. No.: US 2013/0139217 A1
(43) Pub. Date: May 30, 2013

(54) METHOD AND APPARATUS FOR EXECUTING SECURITY POLICY SCRIPT, SECURITY POLICY SYSTEM

(71) Applicant: HUAWEI TECHNOLOGIES CO., LTD., Shenzhen (CN)

(72) Inventor: Yongfang XIE, Shenzhen (CN)

(73) Assignee: HUAWEI TECHNOLOGIES CO., LTD., Shenzhen (CN)

(21) Appl. No.: 13/728,379

(22) Filed: Dec. 27, 2012

Related U.S. Application Data
(63) Continuation of application No. PCT/CN2012/078068, filed on Jul. 2, 2012.

(30) Foreign Application Priority Data
Jun. 30, 2011 (CN) 201110182531.3

(51) Int. Cl. H04L 29/06

(52) U.S. Cl. CPC H04L 63/0281; H04L 63/20
USPC 726/1

(57) ABSTRACT

Embodiments of the present invention provide a method and an apparatus for executing a security policy script as well as a security policy system. The method includes: verifying a signature of a security policy script to be executed, where the security policy script to be executed corresponds to a unique signature, and the signature is used to verify validity of the security policy script; and invoking a script engine to execute the security policy script to be executed after verifying that the signature of the security policy script to be executed is correct, so as to improve security of the security policy script effectively.

This application is a continuation of International Application No. PCT/CN2012/078068, filed on Jul. 2, 2012, which claims priority to Chinese Patent Application No. 201110182531.3, filed on Jun. 30, 2011, both of which are hereby incorporated by reference in their entireties.

### FIELD OF THE INVENTION

The embodiments of the present invention relate to terminal security technologies, and in particular, to a method and an apparatus for executing a security policy script, as well as a security policy system.

### BACKGROUND OF THE INVENTION

In the terminal security field, security inspection and repair are generally performed for terminals by using security policies. The security policies generally come in the form of, for example, executable programs, dynamic databases, and scripts. When a script is used as a security policy, the flexibility of the security policy is high, the security policy is easy to compile, but the script is vulnerable to falsification.

In the prior art, a specific type of a script is used for compiling policies of security inspection and repair, such as VBS, Javascript, and Python script. The system includes a terminal security proxy apparatus and a management server. The terminal security proxy apparatus includes a script host program, a script engine, and a security policy script. The script engine is capable of executing the security policy script, and the script host program is used to manage security policies, invoke the script engine, and communicate with the management server. The management server may notify the terminal security proxy apparatus of security policy scripts that are to be executed. The result of the execution may be transmitted by the terminal security proxy apparatus to the management server to present a security report.

The security policy scripts are in the format of texts. Therefore, the security policy scripts are vulnerable to falsification, or the whole script file is replaced maliciously, which results in that the security policies fail to be executed correctly, or the falsified scripts may even include malicious code and execute insecure operations. Therefore, the security policy scripts in the prior art have security risks.

### SUMMARY OF THE INVENTION

Embodiments of the present invention provide a method and an apparatus for executing a security policy script as well as a security policy system to improve security of the security policy script.

The objectives of the embodiments of the present invention are achieved through the following technical solutions:

A method for executing a security policy script includes:

verifying a signature of a security policy script to be executed, where the security policy script to be executed corresponds to a unique signature, and the signature is used to verify validity of the security policy script; and

invoking a script engine to execute the security policy script to be executed after verifying that the signature of the security policy script to be executed is correct.

An apparatus for executing a security policy script includes:

a script host program module, configured to verify a signature of a security policy script to be executed, where the security policy script to be executed corresponds to a unique signature, and the signature is used to verify validity of the security policy script; and invoke a script engine after verifying that the signature of the security policy script to be executed is correct; and

a script engine, configured to execute the security policy script to be executed as invoked by the script host program module after the script host program module successfully verifies the signature of the security policy script to be executed.

With a method and an apparatus for executing a security policy script as well as a security policy system in the embodiments of the present invention, a signature of a security policy script to be executed is verified, where the security policy script to be executed corresponds to a unique signature, and the signature is used to verify validity of the security policy script; and a script engine is invoked to execute the security policy script to be executed after it is verified that the signature of the security policy script to be executed is correct, thereby improving security of the security policy script effectively.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these drawings without creative efforts.

FIG. 1 is a schematic flowchart of a method for executing a security policy script according to an embodiment of the present invention;

FIG. 2 is a schematic flowchart of an embodiment of the present invention;

FIG. 3 is a first schematic structural diagram of an apparatus for executing a security policy script according to an embodiment of the present invention; and

FIG. 4 is a second schematic structural diagram of an apparatus for executing a security policy script according to an embodiment of the present invention.

### DETAILED DESCRIPTION OF THE EMBODIMENTS

To make the solutions of the present invention more comprehensible for persons skilled in the art, the following clearly and completely describes the technical solutions according to the embodiments of the present invention with reference to the accompanying drawings in the embodiments of the present invention. Apparently, the embodiments in the following description are merely a part rather than all of the embodiments of the present invention. All other embodiments obtained by persons of ordinary skill in the art based on the embodiments of the present invention without creative efforts shall fall within the protection scope of the present invention.

An embodiment of the present invention provides a method for executing a security policy script. An apparatus for executing a security policy script is used as an example to describe the process of the method. FIG. 1 is a schematic flowchart of a method for executing a security policy script according to an embodiment of the present invention. As shown in FIG. 1, the method includes the following steps:

Step 101: Verify a signature of a security policy script to be executed, where the security policy script to be executed corresponds to a unique signature, and the signature is used to verify validity of the security policy script.

In this embodiment, every security policy script configured on a terminal is matched with a corresponding signature. The signature is used to verify the validity of the security policy script. Specifically, the signature is the identifier information that is corresponding to the security policy script and is uniquely obtained according to the security policy script, the signature of the security policy script is verified first to confirm validity of the security policy script when the security policy script is executed after the security policy script is matched with the signature. A security policy script is valid if the security policy script is not forged or falsified by persons other than a publisher.

Step 102: Invoke a script engine to execute the security policy script to be executed after verifying that the signature of the security policy script to be executed is correct.

In step 101, if it is verified that the signature of the security policy script is correct, it indicates that the security policy script is valid, and then the script engine can be invoked to execute the security policy script that is confirmed as valid.

In the above embodiment of the present invention, the corresponding signature is set for each security policy script. The signature is used to verify validity of the security policy script. That is, before the security policy script is executed, it can be verified whether the security policy script is falsified or replaced in an unauthorized way, so as to improve the reliability of executing the security policy script.

Specifically, as described above, in the embodiment of the present invention, each security policy script matches a signature. The signature is used to verify validity of the security policy script. Generally, the signature of the security policy script may be generated and distributed by its publisher. The signature of the security policy script may be stored in many ways. For example, the signature of the security policy script is stored in a comment field of each security policy script in a text format, or the signature of each security policy script is stored separately. A signature and a verification manner may be set according to different requirement, as long as it can be ensured that the signature is not easy to falsify. For example, the signature of the security policy script may be obtained by encrypting the digest of the security policy script by using a private key in a key pair when the security policy script is published; or may be obtained by calculating the digest of the security policy script according to a Hash digest algorithm when the security policy script is published.

A terminal device may store one or more security policy scripts. The security policy scripts are scripts compiled for security tasks, and can perform specified security inspection (for example, determine whether a registry entry exists) and security-specific actions (for example, cancel an insecure sharing). The security policy scripts are all managed by a script host program module.

In step 101, the signature of the security policy script to be executed may be verified in the following manners:

In the above embodiment of the present invention, verifying the signature of the security policy script to be executed may be: An apparatus for executing a security policy script verifies the signature of the security policy script to be executed; or, an apparatus for executing a security policy script requests a management server to verify the signature of the security policy script, the management server performs the verification, and a script host program module receives a verification result of the management server.

In a case that the signature is obtained by encrypting the digest of the security policy script by using the private key in the key pair, the key pair that includes a public key and a private key is generated. When the script is published, after the digest of the script is encrypted by using the private key and is used as the signature of the script, the script is published together with the script. At the time of verifying the signature of the security policy script to be executed, the digest of the script is calculated first, and then the public key is used to decrypt the signature to obtain the digest of the script. The digest of the script obtained by decryption is compared with the digest of the script obtained by calculation; if consistent, the verification succeeds; otherwise, the verification fails. The signatures may be compared on the apparatus for executing a security policy script, or may be compared on the management server. If the signatures is compared on the apparatus for executing a security policy script, the decryption and the verification both are performed on the apparatus for executing a security policy script; if the signatures is compared on the management server, the apparatus for executing a security policy script sends the calculated digest of the security policy script to be executed and the stored signature of the security policy script to the management server, the management server uses the public key in the key pair to complete decryption and comparison, and then the management server returns a verification result to the apparatus for executing a security policy script.

In a case that the digest of the script is calculated by using a user-defined Hash digest algorithm to generate the signature, the signature is verified on the management server. In this case, a client does not necessarily store the signature. Each time before the script is executed, the signature is calculated, and then is compared with that stored in the server. For example, the apparatus for executing a security policy script calculates, by using the Hash digest algorithm, the signature of the security policy script to be executed to obtain the signature, and sends the signature obtained by the calculation to the management server. The management server compares the signature obtained by the calculation with the stored signature of the security policy script to be executed; if consistent, the verification succeeds; otherwise, the verification fails. The management server returns a comparison result to the apparatus for executing a security policy script.

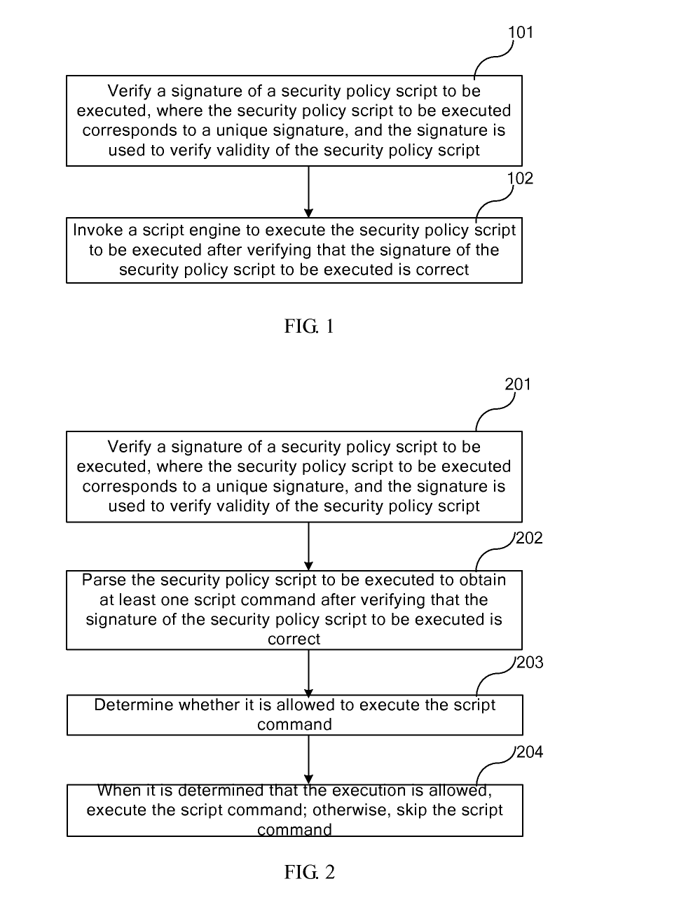

FIG. 2 is a schematic flowchart of a specific embodiment of the present invention. As shown in FIG. 2, the following steps are included:

Step 201: Verify a signature of a security policy script to be executed, where the security policy script to be executed corresponds to a unique signature, and the signature is used to verify validity of the security policy script.

Step 202: Parse the security policy script to be executed to obtain at least one script command after verifying that the signature of the security policy script to be executed is correct.

Step 203: Determine whether it is allowed to execute the script command.

Step 204: When it is determined that the execution is allowed, execute the script command; otherwise, skip the script command.

In the above embodiment, step 201 is similar to step 101, and is not repeated here any further.

In step 202, a security policy script may be parsed to obtain a plurality of independent commands or statements, which are uniformly called script commands in the embodiments of the present invention.

In step 203, at the time of executing a security policy script to be executed, each script command may be filtered, a script command allowed for execution is executed, and a script command that is not allowed for execution is skipped. Determining whether a script command is allowed for execution may be specifically: filtering at least one script command according to a command filtering database, and determining whether the script command is allowed for execution, where the command filtering database configured includes a white list including script commands allowed for execution, and/or a blacklist including script commands that are not allowed for execution. The command filtering database needs to be periodically updated.

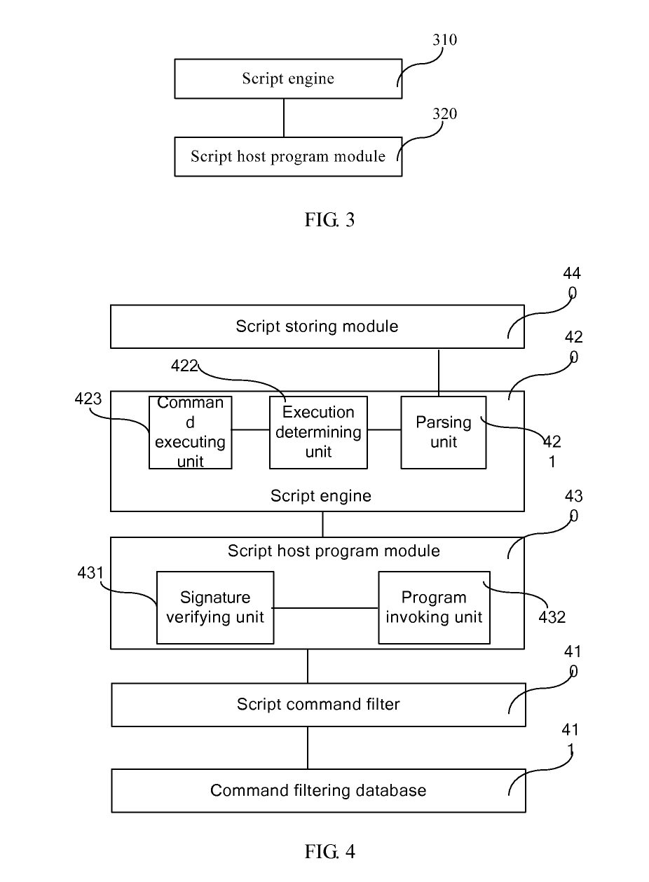

FIG. 3 shows an apparatus for executing a security policy script according to an embodiment of the present invention, as shown in FIG. 3, the apparatus includes: a script host program module 320, configured to verify a signature of a security policy script to be executed, where the security policy script to be executed corresponds to a unique signature, and the signature is used to verify validity of the security policy script; and invoke a script engine 310 after verifying that the signature of the security policy script is correct; and

the script engine 310, configured to execute the security policy script to be executed as invoked by the script host program module 320 after the script host program module 320 successfully verifies the signature of the security policy script to be executed.

In the above embodiment of the present invention, the corresponding signature is set for a security policy script. The signature is used to verify validity of the security policy script. That is, before the security policy script is executed, it can be verified whether the security policy script is falsified or replaced in an unauthorized way, so as to improve the reliability of executing the security policy script.

Specifically, as shown in FIG. 4, the above embodiment of the present invention may further include a script command filter 410. The script command filter 410 is configured to determine whether a script command is allowed for execution. Correspondingly, a command filtering database 411 is included, and the command filtering database 411 includes a white list including script commands allowed for execution and/or a blacklist including script commands that are not allowed for execution.

The script command filter 410 is specifically configured to filter at least one script command according to the configured command filtering database 411 to determine whether the script command is allowed for execution.

The script engine 420 includes:

a parsing unit 421, configured to parse the security policy script to be executed to obtain at least one script command;

an execution determining unit 422, configured to invoke the script command filter to determine whether the script command is allowed for execution; and

a command executing unit 423, configured to receive a determination result returned by the script command filter; when it is determined that the execution is allowed, execute the script command; otherwise, skip the script command.

The script host program module 430 includes:

a signature verifying unit 431, configured to verify a signature of the security policy script to be executed; or, request a management server to verify a signature of the security policy script, and receive an verification result of the management server after the management server performs the verification; and

a program invoking unit 432, configured to invoke the script engine 420 after the signature verifying unit 431 verifies that the signature of the security policy script to be executed is correct.

The apparatus for executing a security policy script may further include a script storing module 440, configured to store at least one security policy script.

Further, an embodiment of the present invention provides a security policy system. The security policy system includes the apparatus for executing a security policy script and the management server described above. The apparatus for executing a security policy script is set on each of at least one terminal device, and is connected to the management server.

In the embodiment of the present invention, the apparatus for executing a security policy script may be set on each terminal device, and work with the same management server to verify the validity of a security script. A plurality of apparatuses for executing a security policy script is connected to the management server, and is managed by the management server in a centralized way. Specifically, the management server may control the apparatus for executing a security policy script on the terminal device to execute the security policy script; after executing the security policy script, the apparatus for executing a security policy script returns an execution result to the management server.

With the method and the apparatus for executing a security policy script as well as the security policy system according to the embodiments of the present invention, the correctness and legality of a script and a script command are verified to prevent disruptive operations on a script policy.

Persons of ordinary skill in the art should understand that all or part of the steps of the methods in the embodiments may be implemented by a program instructing relevant hardware. The program may be stored in a computer readable storage medium. When the program runs, the steps of the methods in the embodiments are performed. The storage medium may be any medium capable of storing program codes, such as ROM, RAM, a magnetic disk, or an optical disk.

Finally, it should be noted that the above embodiments are intended to describe the technical solutions of the present invention, but not intended to limit the present invention. Although the present invention is described in detail with reference to the foregoing embodiments, persons of ordinary skill in the art should understand that they can still make modifications to the technical solutions described in the foregoing embodiments or make substitutions to some technical features thereof, and such modifications or substitutions cannot make the essence of the corresponding technical solutions depart from the idea and scope of the technical solutions of the embodiments of the present invention.

What is claimed is:

1. A method performed by a terminal security proxy apparatus in the network for executing a security policy script, comprising:
verifying a signature of a security policy script to be executed, wherein the security policy script to be executed corresponds to a unique signature, and the signature is used to verify validity of the security policy script; and
invoking a script engine to execute the security policy script to be executed after verifying that the signature of the security policy script to be executed is correct.

2. The method performed by a terminal security proxy apparatus in the network for executing a security policy script according to claim 1, wherein:
the invoking a script engine to execute the security policy script comprises:
parsing the security policy script to be executed to obtain at least one script command;
determining whether it is allowed to execute the script command; and
when it is determined that the execution is allowed, executing the script command; otherwise, skipping the script command.

3. The method performed by a terminal security proxy apparatus in the network for executing a security policy script according to claim 2, wherein:
the determining whether it is allowed to execute the script command comprises:
filtering the at least one script command according to a command filtering database to determine whether the script command is allowed for execution, wherein the command filtering database comprises a white list including script commands allowed for execution and/or a blacklist including script commands that are not allowed for execution.

4. The method performed by a terminal security proxy apparatus in the network for executing a security policy script according to claim 1, wherein:
the verifying a signature of a security policy script to be executed comprises:
verifying the signature of the security policy script to be executed;
or
requesting a management server to verify the signature of the security policy script, and receiving a verification result of the management server after the management server performs the verification.

5. The method performed by a terminal security proxy apparatus in the network for executing a security policy script according to claim 4, wherein:
the signature is obtained by encrypting a digest of the security policy script by using a private key in a key pair, or is obtained by calculating a digest of the security policy script by using a Hash digest algorithm.

6. The method performed by a terminal security proxy apparatus in the network for executing a security policy script according to claim 2, wherein:
the verifying a signature of a security policy script to be executed comprises:
verifying the signature of the security policy script to be executed;
or
requesting a management server to verify the signature of the security policy script, and receiving a verification result of the management server after the management server performs the verification.

7. The method performed by a terminal security proxy apparatus in the network for executing a security policy script according to claim 6, wherein:
the signature is obtained by encrypting a digest of the security policy script by using a private key in a key pair, or is obtained by calculating a digest of the security policy script by using a Hash digest algorithm.

8. The method performed by a terminal security proxy apparatus in the network for executing a security policy script according to claim 3, wherein:
the verifying a signature of a security policy script to be executed comprises:
verifying the signature of the security policy script to be executed;
or
requesting a management server to verify the signature of the security policy script, and receiving a verification result of the management server after the management server performs the verification.

9. The method performed by a terminal security proxy apparatus in the network for executing a security policy script according to claim 8, wherein:
the signature is obtained by encrypting a digest of the security policy script by using a private key in a key pair, or is obtained by calculating a digest of the security policy script by using a Hash digest algorithm.

10. An apparatus for executing a security policy script, comprising:
a script host program module, configured to verify a signature of a security policy script to be executed, wherein the security policy script to be executed corresponds to a unique signature, and the signature is used to verify validity of the security policy script; and invoke a script engine after verifying that the signature of the security policy script to be executed is correct; and
a script engine, configured to execute the security policy script to be executed as invoked by the script host program module after the script host program module successfully verifies the signature of the security policy script to be executed.

11. The apparatus for executing a security policy script according to claim 10, further comprising:
a script command filter, configured to determine whether a script command is allowed for execution, wherein
the script engine comprises:
a parsing unit, configured to parse the security policy script to be executed to obtain at least one script command;
an execution determining unit, configured to invoke the script command filter to determine whether the script command is allowed for execution; and
a command executing unit, configured to receive a determination result returned by the script command filter; when it is determined that the execution is allowed, execute the script command; otherwise, skip the script command.

12. The apparatus for executing a security policy script according to claim 11, further comprising:
a command filtering database, wherein the command filtering database comprises a white list including script commands allowed for execution and/or a blacklist including script commands that are not allowed for execution, wherein
the script command filter is specifically configured to filter the at least one script command according to the configured command filtering database to determine whether the script command is allowed for execution.

13. The apparatus for executing a security policy script according to claim 10, wherein the script host program module comprises:
a signature verifying unit, configured to verify the signature of the security policy script to be executed; or, request a management server to verify the signature of the security policy script, and receive an verification result of the management server after the management server performs the verification; and
a program invoking unit, configured to invoke a script engine after the signature verifying unit verifies that the signature of the security policy script to be executed is correct.

14. The apparatus for executing a security policy script according to claim 11, wherein the script host program module comprises:
a signature verifying unit, configured to verify the signature of the security policy script to be executed; or, request a management server to verify the signature of the security policy script, and receive an verification result of the management server after the management server performs the verification; and
a program invoking unit, configured to invoke a script engine after the signature verifying unit verifies that the signature of the security policy script to be executed is correct.

15. The apparatus for executing a security policy script according to claim 12, wherein the script host program module comprises:
a signature verifying unit, configured to verify the signature of the security policy script to be executed; or, request a management server to verify the signature of the security policy script, and receive an verification result of the management server after the management server performs the verification; and
a program invoking unit, configured to invoke a script engine after the signature verifying unit verifies that the signature of the security policy script to be executed is correct.

16. A security policy system, comprising the apparatus for executing a security policy script and the management server, wherein the apparatus for executing a security policy script comprising:
a script host program module, configured to verify a signature of a security policy script to be executed, wherein the security policy script to be executed corresponds to a unique signature, and the signature is used to verify validity of the security policy script; and invoke a script engine after verifying that the signature of the security policy script to be executed is correct; and
a script engine, configured to execute the security policy script to be executed as invoked by the script host program module after the script host program module successfully verifies the signature of the security policy script to be executed;
wherein the apparatus for executing a security policy script is set on each of at least one terminal device, and is connected to the management server.

17. A security policy system, comprising the apparatus for executing a security policy script and the management server, wherein the apparatus for executing a security policy script comprising:
a script host program module, configured to verify a signature of a security policy script to be executed, wherein the security policy script to be executed corresponds to a unique signature, and the signature is used to verify validity of the security policy script; and invoke a script engine after verifying that the signature of the security policy script to be executed is correct; and
a script engine, configured to execute the security policy script to be executed as invoked by the script host program module after the script host program module successfully verifies the signature of the security policy script to be executed;
a script command filter, configured to determine whether a script command is allowed for execution, wherein
the script engine comprises:
a parsing unit, configured to parse the security policy script to be executed to obtain at least one script command;
an execution determining unit, configured to invoke the script command filter to determine whether the script command is allowed for execution; and
a command executing unit, configured to receive a determination result returned by the script command filter; when it is determined that the execution is allowed, execute the script command; otherwise, skip the script command;
wherein the apparatus for executing a security policy script is set on each of at least one terminal device, and is connected to the management server.

18. A security policy system, comprising the apparatus for executing a security policy script and the management server, wherein the apparatus for executing a security policy script comprising:
a script host program module, configured to verify a signature of a security policy script to be executed, wherein the security policy script to be executed corresponds to a unique signature, and the signature is used to verify validity of the security policy script; and invoke a script engine after verifying that the signature of the security policy script to be executed is correct; and
a script engine, configured to execute the security policy script to be executed as invoked by the script host program module after the script host program module successfully verifies the signature of the security policy script to be executed;
a command filtering database, wherein the command filtering database comprises a white list including script commands allowed for execution and/or a blacklist including script commands that are not allowed for execution, wherein
the script command filter is specifically configured to filter the at least one script command according to the configured command filtering database to determine whether the script command is allowed for execution;
wherein the apparatus for executing a security policy script is set on each of at least one terminal device, and is connected to the management server.

19. A security policy system, comprising the apparatus for executing a security policy script and the management server, wherein the apparatus for executing a security policy script comprising:
a script host program module, configured to verify a signature of a security policy script to be executed, wherein the security policy script to be executed corresponds to a unique signature, and the signature is used to verify validity of the security policy script; and invoke a script engine after verifying that the signature of the security policy script to be executed is correct; and
a script engine, configured to execute the security policy script to be executed as invoked by the script host program module after the script host program module successfully verifies the signature of the security policy script to be executed;
wherein the script host program module comprises:
a signature verifying unit, configured to verify the signature of the security policy script to be executed; or, request a management server to verify the signature of the security policy script, and receive an verification result of the management server after the management server performs the verification; and
a program invoking unit, configured to invoke a script engine after the signature verifying unit verifies that the signature of the security policy script to be executed is correct;
wherein the apparatus for executing a security policy script is set on each of at least one terminal device, and is connected to the management server.
